(19) United States
(12) Patent Application Publication
(10) Pub. No.: US 2013/0215917 A1
(43) Pub. Date: Aug. 22, 2013

(54) LASER SCANNING DEVICE AND LASER SCANNING METHOD

(71) Applicant: SAMSUNG ELECTRO-MECHANICS CO., LTD., (US)

(72) Inventor: Taeg Gyum Kim, Suwon (KR)

(73) Assignee: SAMSUNG ELECTRO-MECHANICS CO., LTD., Suwon (KR)

(21) Appl. No.: 13/773,418

(22) Filed: Feb. 21, 2013

(30) Foreign Application Priority Data
Feb. 21, 2012 (KR) 10-2012-0017498

(51) Int. Cl. G02B 19/00

(52) U.S. Cl. CPC G02B 19/00
USPC 372/24

(57) ABSTRACT

Disclosed herein is a laser scanning device including: a laser emitting unit that emits a laser beam; a first optical unit that condenses the laser beam; a second optical unit that transmits the laser beam passing through the beam extending unit; and a third optical unit that scans the laser beam passing through the second optical unit to a measure object.

### CROSS REFERENCE TO RELATED APPLICATION

This application claims the benefit of Korean Patent Application No. 10-2012-0017498, filed on Feb. 21, 2012, entitled “Laser Scanning Device and Laser Scanning Method”, which is hereby incorporated by reference in its entirety into this application.

### BACKGROUND OF THE INVENTION

1. Technical Field

The present invention relates to a laser scanning device and a laser scanning method.

2. Description of the Related Art

For forming circuit patterns on a printed circuit board, a method for forming a circuit by forming a plating thickness at the time of plating copper to a predetermined height, laminating a dry film, partially removing the dry film by exposure and development, etching a copper plating layer of an opened portion, and peeling the dry film has been used.

In the technology of manufacturing circuit patterns, a manufacturing method using the dry film as etch resist has several defects.

Further, a pattern forming defect among the aforementioned defects occurs due to mask film damage and pollution, dry film scratch, foreign objects on the dry film, lifting due to degradation in adhesion between the dry film and a substrate, lifting due to foreign objects between the dry film and the substrate, or the like, as direct factors.

In particular, defects of the circuit patterns are continued to the circuit pattern damage of the substrate by the development and etching processes.

Therefore, a need exists for a method for rapidly inspecting several defects, or the like, which can easily remove the factors of causing the defects to save manufacturing costs.

However, an automatic optical inspection (AOI) method in accordance with the related art cannot inspect the defects. The reason is that a difference in reflectance between an exposure layer and a non-exposure layer and among several defects (foreign objects, pollution, or the like) is not large and a scattered diffusion effect is large to degrade image quality. A method for solving the problems is that the laser scanning device performs laser scanning. (Herein, the laser scanning device has been prevalently used in a field of inspecting circuit patterns on a printed circuit board, a cell biology field, and a field of inspecting a semiconductor chip, a field of forming electrode patterns on a substrate as disclosed in Korean Patent Laid-Open Publication No. 1991-0006747).

In particular, the laser scanning device may simultaneously measure reflected light and scattered light to provide high quality of a circuit pattern image and solve several defects occurring during a process of manufacturing circuit patterns.

However, the existing laser scanning device may deteriorate resolution due to a limitation of a spot size of a beam condensed to a surface to be measured.

Describing in more detail, when the laser beam from the laser scanning device is condensed by a lens, a size of a beam at a focus is a*f/D. Here, a is a constant relying on the quality of the laser beam, λ, is a wavelength of the laser beam, f is a focal length of the lens, and D is a diameter of a laser balance beam.

Therefore, in order to decrease the size of the beam condensed to the lens, the quality of the beam needs to be good, the lens needs to have a short focal length, the wavelength of the laser beam needs to be short, and the diameter of the laser beam needs to be large.

However, all of the above conditions rely on measurement conditions and therefore, cannot be easily controlled.

In particular, in the case of the high-speed laser scanning, the diameter D of the beam relies on a size of a scanning unit. That is, in the case of the high-speed laser emitting unit, the size of the laser beam is small with the increase of the scanning unit speed.

Therefore, at the time of the high-speed laser scanning, it is difficult to measure high resolution image or perform high resolution laser processing.

### PRIOR ART DOCUMENT

### Patent Document

(Patent Document 1) Korean Patent Laid-Open Publication No. 1991-0006747

### SUMMARY OF THE INVENTION

The present invention has been made in an effort to provide a laser scanning device and a laser scanning method capable of measuring high resolution.

The present invention also has been made in an effort to provide a laser scanning device and a laser scanning method capable of extending a laser scanning width.

According to a preferred embodiment of the present invention, there is provided a laser scanning device, including: a laser emitting unit that emits a laser beam; a first optical unit that condenses the laser beam; a beam extending unit that extends a width of the laser beam passing through the first optical unit; a second optical unit that transmits the laser beam passing through the beam extending unit; and a third optical unit that scans the laser beam passing through the second optical unit to a measure object.

The laser scanning device may further include: a beam deflecting unit that reflects the laser beam emitted from the laser emitting unit toward the first optical unit at a predetermined angle.

The beam extending unit may be configured of an extending slit formed with a slit hole through which the laser beam is passed.

A size of the slit hole may be set to be 1 μm to 10 μm.

The first optical unit may be configured of a first lens that condenses the laser beam emitted from the laser emitting unit to the beam extending unit.

The second optical unit may be configured of a second lens that transmits the laser beam passing through the beam extending unit to the third optical unit in parallel.

The third optical unit may be configured of a scan lens that condenses the laser beam passing through the second optical unit to the measure object.

According to another preferred embodiment of the present invention, there is provided a laser scanning method, including: a emitting step of emitting a laser beam through a laser emitting unit; a condensing step of condensing the laser beam subjected to the scanning step through a first optical unit; an extending step of extending a width of the laser beam subjected to the condensing step through a beam extending unit; a transmitting step of transmitting the laser beam subjected to the extending step through a second optical unit; and a scanning step of scanning the laser beam subjected to the transmitting step to a measure object through a third optical unit.

The laser scanning method may further include: a deflecting step of reflecting the laser beam emitted at the emitting step to the first optical unit through a beam deflecting unit at a predetermined angle.

The beam extending unit may be configured of an extending slit formed with a slit hole through which the laser beam is passed.

A size of the slit hole may be set to be 1 μm to 10 μm.

At the condensing step, the laser beam scanned at the scanning step may be condensed to the extending slit by configuring the first optical unit as a first lens.

At the transmitting step, the laser beam extending at the extending step may be transmitted to the third optical unit in parallel by configuring the second optical unit as a second lens.

At the scanning step, the laser beam transmitted at the transmitting step may be condensed to a measure object by configuring the third optical unit as a scanning lens.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a laser scanning device in accordance with a preferred embodiment of the present invention.

FIG. 2 is a conceptual diagram showing main components of the laser scanning device in accordance with the preferred embodiment of the present invention.

FIG. 3 is a graph showing a result of measuring a width of a laser beam passing through a beam extending unit in the laser scanning device according to the preferred embodiment of the present invention.

FIG. 4 is a flow chart showing a laser scanning method in accordance with another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

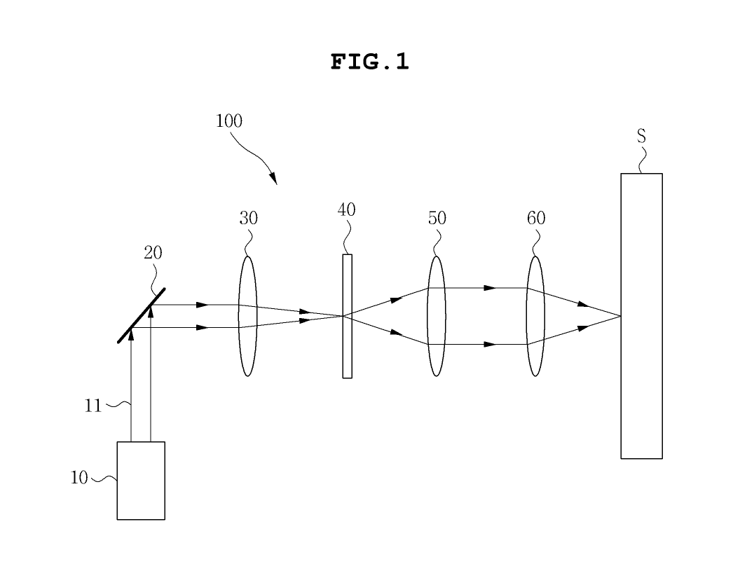

FIG. 1 is a configuration diagram showing a laser scanning device in accordance with a preferred embodiment of the present invention.

Referring to FIG. 1, a laser scanning device 100 in accordance with a preferred embodiment of the present invention includes a laser emitting unit 10, a first optical unit 30, a beam extending unit 40, a second optical unit 50, and a third optical unit 60 and laser-scans a measure object S. Further, the laser scanning device 100 in accordance with the preferred embodiment of the present invention further includes a beam deflecting unit 20.

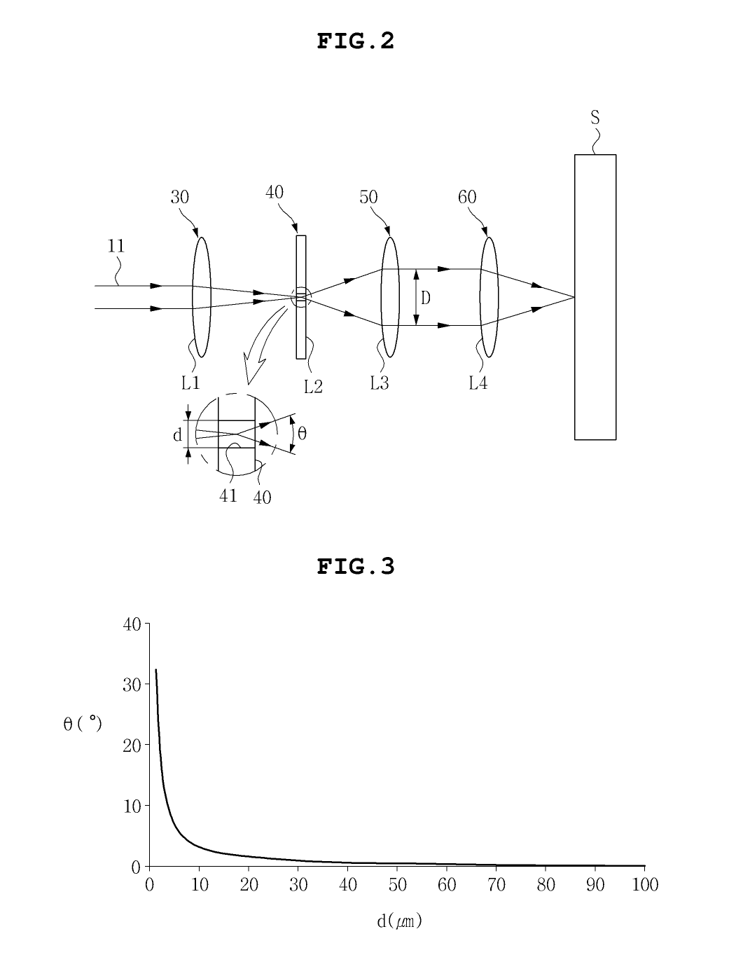

FIG. 2 is a conceptual diagram showing main components of the laser scanning device in accordance with the preferred embodiment of the present invention.

Hereinafter, the laser scanning device 100 in accordance with the preferred embodiment of the present invention will be described in more detail with reference to FIGS. 1 and 2.

First, referring to FIG. 1, the laser emitting unit 10 emits a laser beam 11 having a predetermined wavelength in a emitting direction. In this case, the laser emitting unit 10 may be configured of a laser diode that amplifies light by induced emission.

Referring to FIG. 1, the beam deflecting unit 20 is disposed between the laser emitting unit 10 and the first optical unit 30 to reflect the laser beam 11 emitted from the laser emitting unit 10 toward the first optical unit 30 at a predetermined angle. In this case, in the laser scanning device 100 according to the preferred embodiment of the present invention, the beam deflecting unit 20 is not necessarily disposed between the laser emitting unit 10 and the first optical unit 30. For example, the beam deflecting unit 20 may be disposed between the second optical unit 50 and the third optical unit 60. Alternatively, the beam deflecting unit 20 may be disposed between the laser emitting unit 10 and the first optical unit 30 and between the second optical unit 50 and the third optical unit 60, respectively.

Further, the beam deflecting unit 20 may include, for example, a reflection mirror (not shown) and a rotating unit (not shown) that rotates the reflection mirror at a predetermined angle. Therefore, the beam deflecting unit 20 may rotate the reflection mirror at a rotating angle by the rotating unit and may control a scanning direction of the laser beam 11 toward the first optical unit 30. However, a configuration of the beam deflecting unit 20 of the laser scanning device 100 in accordance with the preferred embodiment of the present invention is not limited as including only the reflection mirror and the rotating unit.

Referring to FIGS. 1 and 2, the first optical unit 30 condenses the laser beam 11 emitted from the laser emitting unit 10 to the beam extending unit 40. In this case, the first optical unit 30 has positive (+) power and may be configured of a first lens L1 that is protruded to both sides or one side, but a shape of the first optical unit 30 in accordance with the preferred embodiment of the present invention is not limited thereto.

Referring to FIGS. 1 and 2, the beam extending unit 40 is configured of an extending slit L2 to extend a width of the condensed laser beam 11 in the first optical unit 30. In this case, the extending slit L2 is configured of a single slit and may be positioned in a focal length of the first optical unit 30, but is not necessarily limited thereto.

Further, a slit hole 41 formed in the extending slit 12 to transmit the laser beam 11 may be formed at 1 μm to 10 μm or 1 μm to 100 μm, but is not necessarily thereto. In this case, an interval (size) of the slit hole 41 of the extending slit L2 may be set to be larger than the wavelength of the laser beam 11.

Here, a width of the laser beam 11 extends while the laser beam 11 condensed to the extending slit L2 from the first optical unit 30 passes through the slit hole 41 of the extending slit L2.

Referring to FIG. 2, the laser scanning device 100 in accordance with the preferred embodiment of the present invention may satisfy a formula of sin θ=λ/d when the width of the laser beam 11 is D, an angle of the width of the laser beam 11 based on the extending slit L2 is θ, the interval of the slit hole 41 is d, and the wavelength of the laser beam 11 is λ.

In this case, it can be appreciated that the angle of the width of the laser beam 11 varies according to the interval of the slit hole 41.

In particular, when the interval of the slit hole 41 extends, it can be appreciated that the width of the laser beam 11 passing through the extending slit L2 extends.

Referring to FIGS. 1 and 2, the second optical unit 50 transmits the laser beam 11 passing through the extending slit L2 to the third optical unit 60. Here, the second optical unit 50 may transmit the laser beam 11 in parallel or constantly transmit the width of the laser beam 11.

In this case, the second optical unit 50 has positive (+) power and may be configured of a second lens L3 that is protruded to both sides or one side, but is not necessarily limited thereto.

Further, the optical unit 50 of the laser scanning device 100 in accordance with the preferred embodiment of the present invention is not necessarily limited as including only the second lens L3. For example, the second optical unit 50 may be configured of a plurality of lenses including the second lens L3.

Referring to FIGS. 1 and 2, the third optical unit 60 scans the laser beam 11 passing through the second optical unit 50 toward the measure object S. Here, the third optical unit 60 may be configured of a scanning lens L4 that condenses the laser beam 11 on the measure object S. In this case, the scanning lens L4 has positive (+) power and may be protruded to both sides or one side, but is not necessarily limited thereto.

In this case, the scanning lens L4 may condense the laser beam 11 so as to minimize the width of the laser beam 11 to minimize of the spot size of the laser beam 11 condensed to the measure object S.

However, the third optical unit 60 of the laser scanning device 100 in accordance with the preferred embodiment of the present invention is not necessarily limited as including only the scanning lens L4. For example, the third optical unit 50 may be configured of a plurality of lenses including the scanning lens L4.

When scanning the measure object S, the laser scanning device 100 in accordance with the preferred embodiment of the present invention configured as described above extends the width of the laser beam 11 through the extending slit L2 to increase the size of the laser beam 11 condensed to the measure object S.

Therefore, when the scanning speed is rapid, the size of the laser beam 11 is small to solve the problem of the decrease in the scanning speed for acquiring a good image.

As a result, the laser scanning device 100 in accordance with the preferred embodiment of the present invention magnifies the size of the laser beam 11 to increase the scanning speed, thereby making it possible to acquire the high-resolution image.

FIG. 3 is a graph showing a result of measuring the width of the laser beam 11 passing through the beam extending unit 40 in the laser scanning device according to the preferred embodiment of the present invention. FIG. 3 shows that the width of the laser beam 11 is changed when the laser beam 11 passes through the extending slit L2 that is the beam extending unit 40. Here, an x axis represents d that is the interval of the extending slit L2 and a y axis represents θ that is the angle of the width of the laser beam 11 measured based on the extending slit L2. In this case, the wavelength λ of the laser beam 11 may be, for example, 0.5 to 0.6 μm, but the preferred embodiment of the present invention is not limited thereto.

In addition, it can be appreciated that when the interval of the extending slit L2 is set to be 10 μm or less, the angle of the width of the laser beam 11 is suddenly increased and when the interval of the extending slit L2 is set to be 1 μm or less, the angle of the width of the laser beam 11 is infinite.

As a result, it can be appreciated that the width of the laser beam 11 is large while the laser beam 11 passes through the extending slit L2.

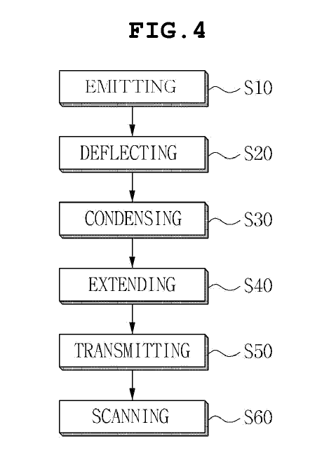

FIG. 4 is a flow chart showing a laser scanning method in accordance with another preferred embodiment of the present invention.

Referring to FIG. 4, the laser scanning method in accordance with the preferred embodiment of the present invention includes a emitting step (S10), an extending step (S40), a transmitting step (S50), and a scanning step (S60) and laser-scans the measure object S. Further, the laser scanning method in accordance with the preferred embodiment of the present invention further includes a deflecting step (S20).

The laser scanning method in accordance with the preferred embodiment of the present invention relates to the scanning method for the laser scanning device 100 in accordance with the preferred embodiment of the present invention. Therefore, like components are denoted by like reference numerals and the same description thereof will be omitted.

Hereinafter, the laser scanning device 100 in accordance with the preferred embodiment of the present invention will be described in more detail with reference to FIGS. 1 to 4.

Referring first to FIGS. 1 and 4, at the emitting step (S10), the laser beam 11 having a predetermined wavelength in a scanning direction is emitted through the laser emitting unit 10. In this case, the laser emitting unit 10 may be configured of a laser diode that amplifies light by induced emission.

Referring to FIGS. 1 and 4, at the deflecting step (S20), the laser beam 11 emitted at the emitting step (S10) is reflected toward the first optical unit 30 at a predetermined angle by the beam deflecting unit 20. In this case, the beam deflecting unit 20 may be disposed between the laser emitting unit 10 and the first optical unit 30, but in the laser scanning method in accordance with the preferred embodiment of the present invention, the position of the beam deflecting unit 20 is not limited thereto. For example, the beam deflecting unit 20 may be disposed between the second optical unit 50 and the third optical unit 60 or may be disposed between the laser emitting unit 10 and the first optical unit 30 and between the second optical unit 50 and the third optical unit 60, respectively.

Further, the beam deflecting unit 20 may include, for example, the reflection mirror and the rotating unit that rotates the reflection mirror at a predetermined angle. Therefore, the beam deflecting unit 20 may rotate the reflection mirror at the rotating angle by the rotating unit and may control the scanning direction of the laser beam 11 toward the first optical unit 30. However, a configuration of the beam deflecting unit 20 of the laser scanning method in accordance with the preferred embodiment of the present invention is not limited as including only the reflection mirror and the rotating unit.

Referring to FIGS. 1 and 4, at the condensing step (S10), the emitted laser beam 11 is condensed through the first optical unit 30.

Here, the first optical unit 30 is configured of the first lens L1 that condenses the laser beam 11 scanned from the laser emitting unit 10 to the beam extending unit 40. Further, the first lens L1 has positive power and may be protruded to both sides, but the laser scanning method in accordance with the embodiment of the present invention, the first lens L1 is not necessarily limited thereto.

Referring to FIGS. 2 and 4, at the extending step (S40), the width of the laser beam 11, which is condensed at the condensing step (S30), is extended through the beam extending unit 40.

Here, the beam extending unit 40 is configured of the extending slit L2 to extend a width of the condensed laser beam 11 in the first optical unit 30. In this case, the extending slit L2 is configured of the single slit and may be positioned in the focal length of the first optical unit 30, but is not necessarily limited thereto.

Further, the slit hole 41 formed in the extending slit 12 to transmit the laser beam 11 may be formed at 1 μm to 10 μm or 1 μm to 100 μm, but is not necessarily thereto. In this case, the interval (size) of the slit hole 41 of the extending slit L2 may be set to be larger than the wavelength of the laser beam 11.

Here, the width of the laser beam 11 extends while the laser beam 11 condensed to the extending slit L2 from the first optical unit 30 passes through the slit hole 41 of the extending slit L2.

Referring to FIG. 2, the laser scanning method in accordance with the preferred embodiment of the present invention may satisfy a formula of sin θ=λ/d {θ=sin (λ/d)⁻¹} when the width of the laser beam 11 is D, the angle of the width of the laser beam 11 based on the extending slit L2 is θ, the interval of the slit hole 41 is d, and the wavelength of the laser beam 11 is λ. In this case, it can be appreciated that the angle of the width of the laser beam is changed. Therefore, it can be appreciated that as the interval of the slit hole 41 extends, the width of the laser beam 11 passing through the extending slit L2 extends.

Referring to FIGS. 1 and 4, at the transmitting step (S50), the laser beam 11 extending at the extending step (S40) is transmitted through the second optical unit 50. Here, at the transmitting step (S50), the laser beam 11 may be transmitted in parallel or the width of the laser beam 11 may be constantly transmitted when the laser beam 11 passes through the second optical unit 50.

Further, the second optical unit 50 has positive (+) power and may be configured of a second lens L3 that is protruded to both sides or one side, but is not necessarily limited thereto.

Further, the second lens L3 may be formed so as to be protruded to the extending slit L2, but the laser scanning method in accordance with the embodiment of the present invention, the shape of the second lens L3 is not necessarily limited thereto.

Referring to FIGS. 1 and 2, the second optical unit 50 transmits the laser beam 11 passing through the extending slit L2 to the third optical unit 60. Here, the second optical unit 50 may transmit the laser beam 11 in parallel or constantly transmit the width of the laser beam 11.

In this case, the second optical unit 50 has positive (+) power and may be configured of the second lens L3 that is protruded to both sides or one side, but is not necessarily limited thereto.

Further, the optical unit 50 of the laser scanning device 100 in accordance with the preferred embodiment of the present invention is not necessarily limited as including the second lens L3. For example, the second optical unit 50 may be configured of a plurality of lenses including the second lens L3.

Referring to FIGS. 1 and 4, at the scanning step (S60), the laser beam 11 transmitted at the transmitting step (S50) is transmitted to the measure object S through the third optical unit 60.

Here, the third optical unit 60 is configured of the scanning lens L4 and may spot the laser beam 11 passing through the second optical unit 50 to the measure object S. In this case, the laser beam 11 may be condensed to the surface of the measure object S by the scanning lens L4 to scan the measure object S.

Further, the scanning lens L4 has positive (+) power and may be protruded to both sides, but in the laser scanning method in accordance with the embodiment of the present invention, the scanning lens L4 is not necessarily limited thereto.

When scanning the measure object S, the laser scanning method in accordance with the preferred embodiment of the present invention configured as described above extends the width of the laser beam 11 at the extending step (S40) to increase the size of the laser beam 11 condensed to the measure object S.

Therefore, when the scanning speed is rapid, the size of the laser beam 11 is small to solve the problem of the decrease in the scanning speed for acquiring a good image.

As a result, the laser scanning method in accordance with the preferred embodiment of the present invention magnifies the size of the laser beam 11 to increase the scanning speed, thereby making it possible to acquire the high-resolution image.

The preferred embodiments of the present invention can increase the accuracy and definition of the image by measuring the high-resolution image.

Further, the preferred embodiments of the present invention can extend the scanning width to improve the scanning speed.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A laser scanning device, comprising:
a laser emitting unit that emits a laser beam;
a first optical unit that condenses the laser beam;
a beam extending unit that extends a width of the laser beam passing through the first optical unit;
a second optical unit that transmits the laser beam passing through the beam extending unit; and
a third optical unit that scans the laser beam passing through the second optical unit to a measure object.

2. The laser scanning device as set forth in claim 1, further comprising: a beam deflecting unit that reflects the laser beam emitted from the laser emitting unit toward the first optical unit at a predetermined angle.

3. The laser scanning device as set forth in claim 1, wherein the beam extending unit is configured of an extending slit formed with a slit hole through which the laser beam is passed.

4. The laser scanning device as set forth in claim 3, wherein a size of the slit hole is set to be 1 μm to 10 μm.

5. The laser scanning device as set forth in claim 1, wherein the first optical unit is configured of a first lens that condenses the laser beam emitted from the laser emitting unit to the beam extending unit.

6. The laser scanning device as set forth in claim 1, wherein the second optical unit is configured of a second lens that transmits the laser beam passing through the beam extending unit to the third optical unit in parallel.

7. The laser scanning device as set forth in claim 1, wherein the third optical unit is configured of a scan lens that condenses the laser beam passing through the second optical unit to the measure object.

8. A laser scanning method, comprising:
a emitting step of emitting a laser beam through a laser emitting unit;
a condensing step of condensing the laser beam subjected to the scanning step through a first optical unit;
an extending step of extending a width of the laser beam subjected to the condensing step through a beam extending unit;
a transmitting step of transmitting the laser beam subjected to the extending step through a second optical unit; and
a scanning step of scanning the laser beam subjected to the transmitting step to a measure object through a third optical unit.

9. The laser scanning method as set forth in claim 8, further comprising: a deflecting step of reflecting the laser beam emitted at the emitting step to the first optical unit through a beam deflecting unit at a predetermined angle

10. The laser scanning method as set forth in claim 8, wherein the beam extending unit is configured of an extending slit formed with a slit hole through which the laser beam is passed.

11. The laser scanning method as set forth in claim 10, wherein a size of the slit hole is set to be 1 μm to 10 μm.

12. The laser scanning method as set forth in claim 10, wherein at the condensing step, the laser beam emitted at the emitting step is condensed to the extending slit by configuring the first optical unit as a first lens.

13. The laser scanning method as set forth in claim 8, wherein at the transmitting step, the laser beam extending at the extending step is transmitted to the third optical unit in parallel by configuring the second optical unit as a second lens.

14. The laser scanning method as set forth in claim 8, wherein at the scanning step, the laser beam transmitted at the transmitting step is condensed to a measure object by configuring the third optical unit as a scanning lens.
